(19) United States
(12) Patent Application Publication
(10) Pub. No.: US 2006/0080170 A1
(43) Pub. Date: Apr. 13, 2006

(54) Method, system, and computer readable medium for token enhanced media

(76) Inventors: Stan Roach, Mountain View, CA (US); Michael Comb, San Carlos, CA (US); Robert Drescher, Menlo Park, CA (US); Armen Najarian, Los Altos, CA (US); Juan Carlos Velten, Highland Village, TX (US)

Correspondence Address: VIERRA MAGEN MARCUS & DENIRO LLP, 575 MARKET STREET SUITE 2500, SAN FRANCISCO, CA, 94105, US

(21) Appl. No.: 10/964,164

(22) Filed: Oct. 13, 2004

(51) Int. Cl. G06F 17/60

(52) U.S. Cl. 705/14

(57) ABSTRACT

A method, system and article of manufacture, including software, that encourages purchases of products or services and identifies measurable loyalty of an individual to a product or service, or in particular how often an individual purchases a product or service during a period of time in response to electronic media, such as a Web advertisement. The method includes providing an electronic media, such as a web banner, paid search results or e-mail to an individual that selects the electronic media and inputs individual information to a server, promotional processing device or Web site. In an embodiment, a software component to identify the individual, such as a cookie, is downloaded to an individual's processing device. In an alternate embodiment, a user identification number generated during a user session is used to identify the individual. A token, such as a first unique code associated with the individual information, is then provided to the individual's account at the server. The individual obtains a second or more tokens from one or more purchases of products at an offline and/or online retailer. The second or more tokens are then input, at the individual's processing device that transfers the information to the server, and in particular the individual's account. An object, such as downloadable music, a gift certificate, incentive, digitally downloadable asset or book, is then provided to the individual in response to the individual obtaining the required number of tokens by purchasing offline products or services.

### FIELD OF THE INVENTION

This invention relates generally to consumer promotions and the Internet or the World Wide Web (“www”), also known as the Web.

### BACKGROUND

There is a need to increase the effectiveness of Web advertising for consumers or individuals purchasing products or services from retailers. Product manufacturers/distributors/marketers, and similarly service providers are interested in purchasing advertising that will effectively sell products or services. However, it is typically difficult to determine whether a particular type of advertising, such as Web advertising, is effective in causing a consumer or individual to purchase a product or service in response to viewing or experiencing a particular advertisement.

Therefore there is a need to increase the effectiveness of Web advertisement or increase the likelihood that an individual will purchase a product or service in response to a particular Web advertisement.

Further, there is a need to demonstrate how a particular Web advertisement affects individual or consumer purchasing behavior during a particular period of time. Advertisement buyers are less likely to purchase Web advertising, or significant amounts of Web advertising relative to overall marketing expenditures, without knowing how affective Web advertising is on consumer purchases. In particular, there is a need to determine whether a consumer purchases a product or service at a retailer, such as a grocery store, in response to a specific Web advertisement at a particular Web site. Further, there is a need to know how many specific products or services during a period of time, such as an advertising campaign, a consumer purchases after viewing a particular Web advertisement.

On-line coupons or coupons available on the Web are one process used to encourage purchases by individuals at retailers. However on-line coupons do not typically encourage repetitive purchases by an individual in response to an initial contact of a Web advertisement. On-line coupons also do not enable continuous contact between the consumer and the product provider/marketer or efficiently aid in observing consumer behavior. Further, on-line coupons often require a complicated and relatively expensive redemption and reporting process. Finally, on-line coupons do not often provide a quick return on investment or increase profits during a particular short period of time.

### SUMMARY

A method, system and article of manufacture, including software, that encourages purchases of products or services and identifies measurable loyalty of an individual to a product or service, or in particular how often an individual purchases a product or service during a period of time in response to electronic media, such as a Web advertisement. The method includes providing an electronic media, such as a web banner, paid search results or e-mail to an individual that selects the electronic media and inputs individual information to a server, promotional processing device or web site. In an embodiment, a cookie is downloaded to an individual's processing device. In an alternate embodiment, a cookie is not used and information from an individual is obtained during a user session. A token, such as a first unique code associated with the individual information, is then provided to the individual's account at the server. The individual obtains a second or more tokens from one or more purchases of products at retailer. In an embodiment, a token is also available from on-line retailers. The second or more tokens are then input, at the individual's processing device that transfers the information to the server, and in particular the individual's account. An object, such as a book, gift certificate, digitally downloadable asset, such as music, or other incentive is then provided to the individual in response to the individual obtaining the required number of tokens by purchasing offline products or services.

In an alternate embodiment, a computer comprises a processor coupled to a storage device that stores a software program. The software program is operable with the processor to obtain individual information in response to an individual selection of an electronic media. A cookie is downloaded to an individual computer to identify the individual in response to the individual selection of the electronic media in an embodiment. A first token associated with the individual information is displayed. The individual obtains a second or more tokens from one or more purchases of products at an offline and/or online retailer. A determination is made whether to provide an object, such as an incentive, to the individual in response to a comparison between the number of tokens input and the number of tokens necessary for the incentive.

In still another embodiment, an article of manufacture, including a computer readable medium, comprises a first software component to obtain individual information in response to an individual selection of an electronic media. A second software component downloads a cookie in response to the individual selection of the electronic media in an embodiment. A third software component displays a first token associated with the individual information and a fourth software component obtains at least a second token obtained from a product purchased by the individual. A fifth software component determines whether to provide an object, such as an incentive, to the individual in response to a comparison between the number of tokens input and the number of tokens necessary for the object.

Other aspects and advantages of the present invention can be seen upon review of the figures, the detailed description, and the claims which follow.

### BRIEF DESCRIPTION OF THE FIGURES

FIG. 1 illustrates a system for token enhanced media.

FIG. 2 is a method according to an embodiment of the invention.

FIG. 3a illustrates a registration form or Web page according to an embodiment of the invention.

FIG. 3b illustrates an individual's account Web page at a first time according to an embodiment of the invention.

FIG. 3c illustrates an individual's account Web page at a second time according to an embodiment of the invention.

FIG. 4 is a workflow diagram according to an embodiment of the invention.

FIG. 5 is software architecture according to an embodiment of the invention.

### DETAILED DESCRIPTION

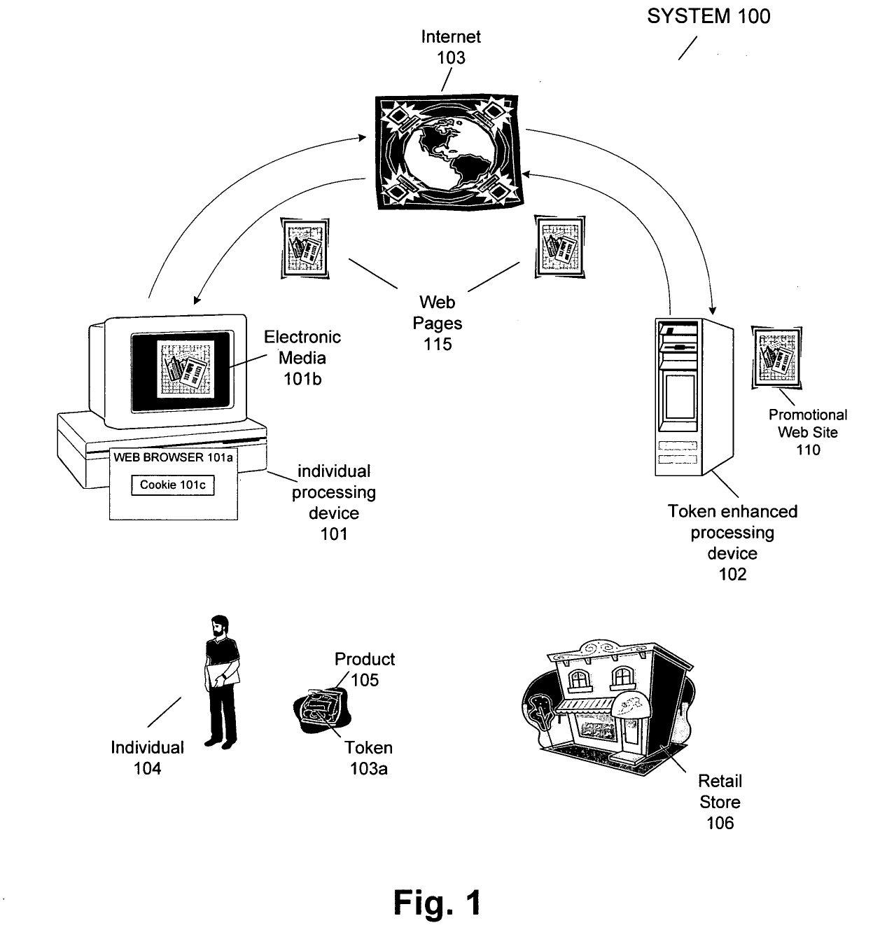

FIG. 1 illustrates a system 100 according to an embodiment of the present invention to encourage an individual 104 to purchase a product 105 (or service) in response to electronic media and identify measurable subsequent loyalty of an individual 104 purchasing the product 105 from offline retailers, such as retail store 106, during a period of time. In an embodiment, product 105 is purchased from an online retailer at an online Web site. After receiving a free token in response to electronic media 101b, individual 104 purchases (or otherwise obtains) one or more products 105 and inputs one or more tokens 103a into a promotional Web site 110 in order to obtain an object, such as gift certificate, after accumulating and inputting a predetermined number of tokens. When and where the products 105 were purchased by individual 104 are recorded by promotional Web site 110 while inputting the tokens and may be used to identify the effectiveness of the electronic media 101b during a selected period of time and the purchasing habits of individual 104.

System 100 includes individual processing device 101 and token enhanced processing device 102, coupled to Internet 103, also known as the Web. As one of ordinary skill in the art would appreciate information is transferred between processing device 101 and 102, by way of Internet 103, using numerous type of technologies. For example, individual processing device 101 accomplishes information transactions with processing device 102 by using the Hypertext Transfer Protocol (“HTTP”), which is a known application protocol. Individual 104 accesses, by way of individual processing device 101, Web pages 115 or documents on the Web (that may include text, graphics, images, sound and/or video) stored on Internet 103 or token enhanced processing device 102 using typically a standard page description language known as the Hypertext Markup Language (“HTML”). HTML provides basic document or Web page formatting and allows for “links” to other Web pages that may be stored on other processing devices. A Uniform Resource Locator (“URL”) having a specific syntax identifies a network path or connection to a Web page stored on a processing device. Embedded hypertext links on a particular Web page can be used to find related information. By clicking on a hypertext link in a particular Web page, individual 104 can display another related Web page or even invoke a related software program.

Retrieval of information is generally achieved by the use of an HTML-compatible “browser” 101a (for example, Microsoft® Explorer) stored on processing device 101. When individual 104 using browser 101a specifies a link via a URL, processing device 101 issues a request to a naming service to map a hostname in the URL to a particular network IP address at which the processing device or server is located. The naming service returns a list of one or more IP addresses that can respond to the request. Using one of the IP addresses, browser 101a establishes a connection to a server. If the server is available, it returns a Web page or other object formatted according to HTML. Browser 101a is an interface for accessing many network and server services.

An example of server services includes obtaining search results on a search result page from a search engine using browser 101a. An individual 104 typically may explore several promising Web sites listed in a Web page of search results. The typical interaction is to follow a link, look at the Web page, and then hit the back button to redisplay the search results. The individual often wants to use the Web page of search results as a persistent launcher that opens the links in another specified view.

In an embodiment, individual 104 is provided with electronic media 101b on processing device 101. In an embodiment, electronic media 101b is a Web advertisement, advertisement electronic file or Web banner provided on a Web page or a Web site to advertise a product or service to an individual 104 viewing the electronic media 101b. A Web site is a set of interconnected web pages, usually including a homepage, generally located on the same server, and prepared and maintained as a collection of information by a person, group or organization. The electronic media 101b may include text, graphics, images, video, sound, singly or in combination.

In another alternate embodiment, electronic media 101b is a Web page displaying search results from a search engine. In embodiments, a search result may be either a sponsored (paid) search result or an organically generated search result. In an embodiment, a manufacturer/distributor/marketer has paid for at least a portion of the search results.

In still another embodiment, electronic media 101b is an e-mail provided to individual processing device 101 that may include a Web advertisement or a link to a Web site having a Web advertisement.

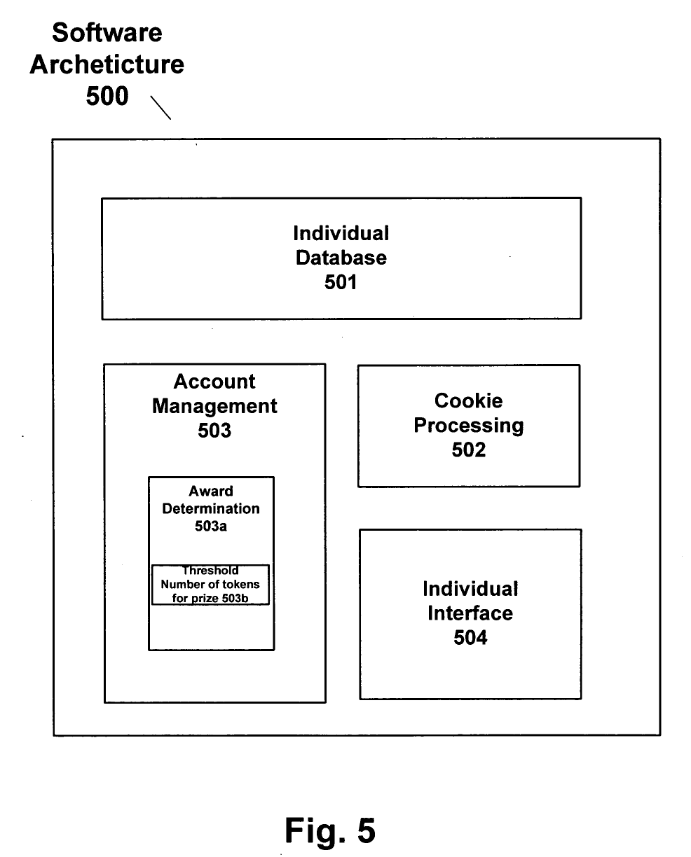

In an embodiment of the present invention, token enhanced processing device 102 shown in FIG. 1 is a server, a mainframe computer, a desktop computer or an equivalent thereof. In an embodiment, processing device 102 includes at least one general-purpose processor and machine-readable memory for storing computer software or machine-readable instructions as illustrated in FIG. 5. In an embodiment, processing device 102 has a distributed architecture or represents many processing devices having respective processors located in near or far physical proximity. In an embodiment, token enhanced processing device 102 stores a software component for providing a promotional web site 110 that stores individual information and individual accounts storing and recording tokens obtained by individual 104. In an embodiment, a promotional web site 110 is provided by software architecture 500 shown in FIG. 5 and described below.

In an embodiment of the present invention, individual processing device 101 shown in FIG. 1 is an information appliance, a desktop computer, handheld computer, telephone, personal digital assistant (PDA), pager or an equivalent thereof. In an embodiment, processing device 101 is coupled to Internet 103 by a wired and/or wireless connection (of which one embodiment may be a cellular network coupled to Internet 103).

In an embodiment, individual 104 purchases or obtains (e.g. by way of a free give away) a product 105 (or a service) having a token 103a from an offline physical site, such as retail store 106. In an alternate embodiment, an individual obtains a product 105 from an online Web site. In an embodiment, individual 104 consumes or uses product 105. In an embodiment, individual 104 purchases product 105 for another individual. In an embodiment, individual 104 uses individual processing device 101 or individual 104 has others use individual processing device 101.

In an embodiment, product 105 is a consumable, such as chips, soda, toothpaste, juice, etc. that is obtained from a grocery store, drug store, mass merchant or convenience store. In an embodiment, product 105 is a garment, accessory or durable good obtained from a retail store.

In embodiments, token 103a includes a unique code or a plurality of alphanumeric symbols. In an embodiment, token 103a is attached to product 105 or included in product 105 packaging. A unique code is a vehicle used to verify that an actual purchase of product 105 has taken place by individual 104. In another embodiment, token 103a is included in or with product 105.

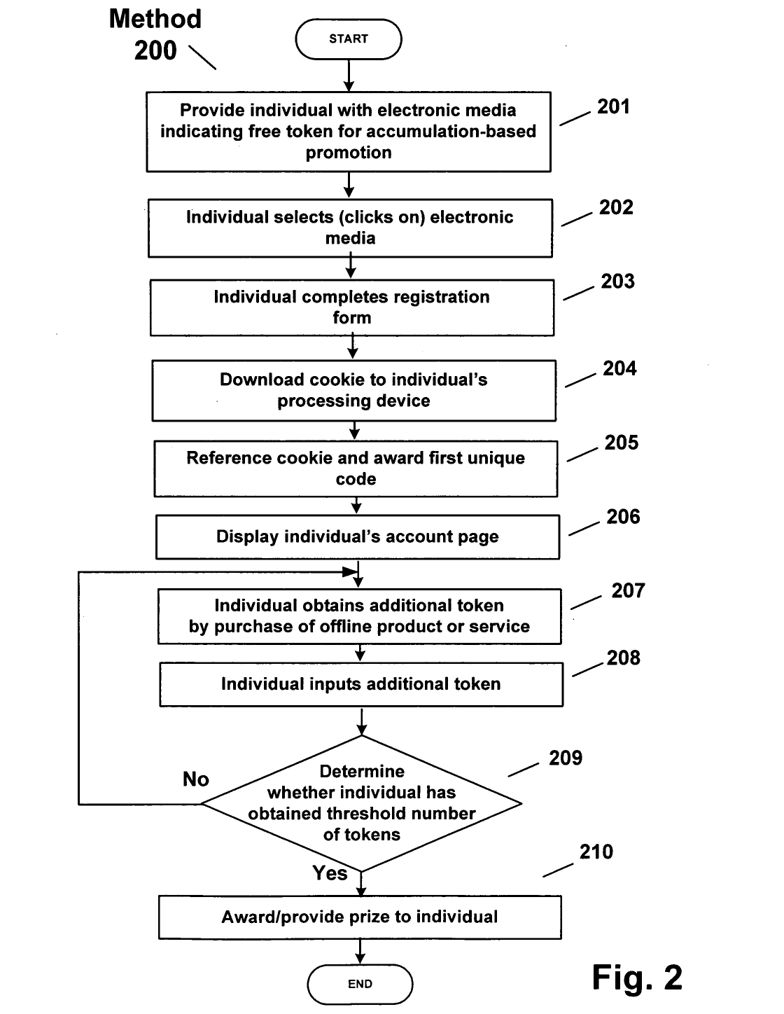

FIG. 2 illustrates a method 200 for encouraging a purchase of a product or service in response to electronic media and identifying measurable subsequent loyalty of an individual purchasing the product from offline/online retailers according to an embodiment of the present invention. As one who is skilled in the art would appreciate, FIG. 2 illustrates logic boxes or steps representing the performance of specific functions. In alternate embodiments, more or fewer logic boxes or steps are used. In an embodiment of the present invention, a logic box or step may represent an execution of a software component (for example, a software program, a software object, a software function, a software subroutine, a software method, a software instance or a code fragment), a hardware operation or individual operation, singly or in combination.

An individual is provided with electronic media indicating a free token in an accumulation-base product or service promotion in logic block 201. In an embodiment, the electronic media is electronic media 101b shown in FIG. 1 and described above.

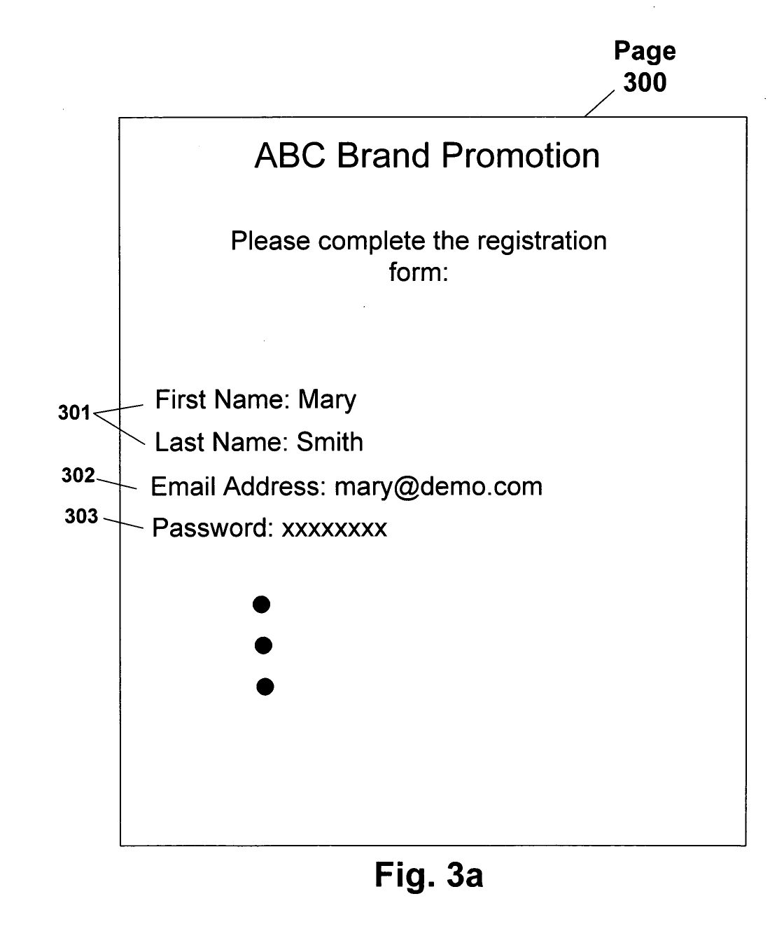

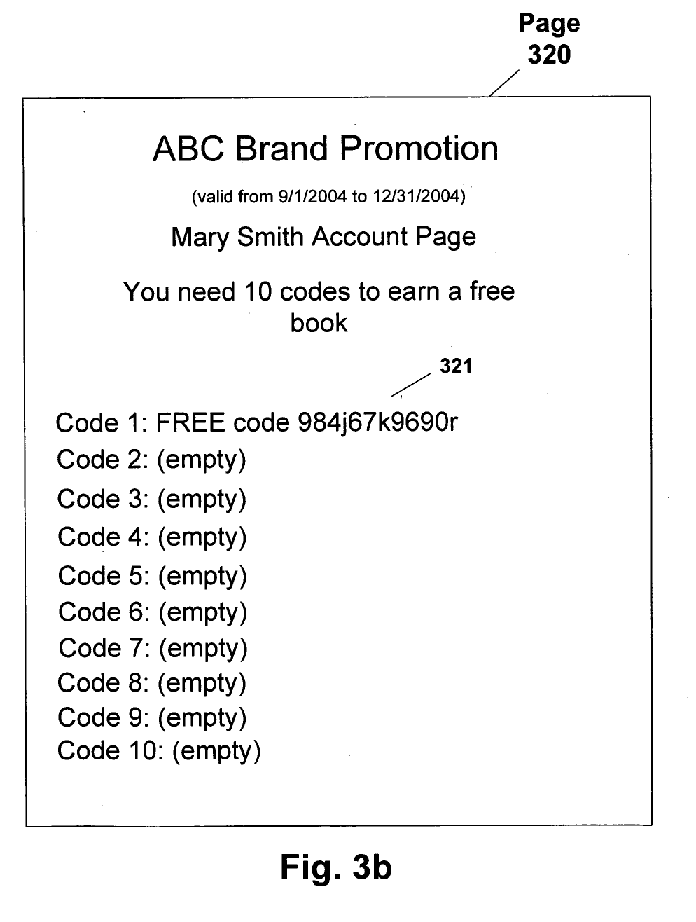

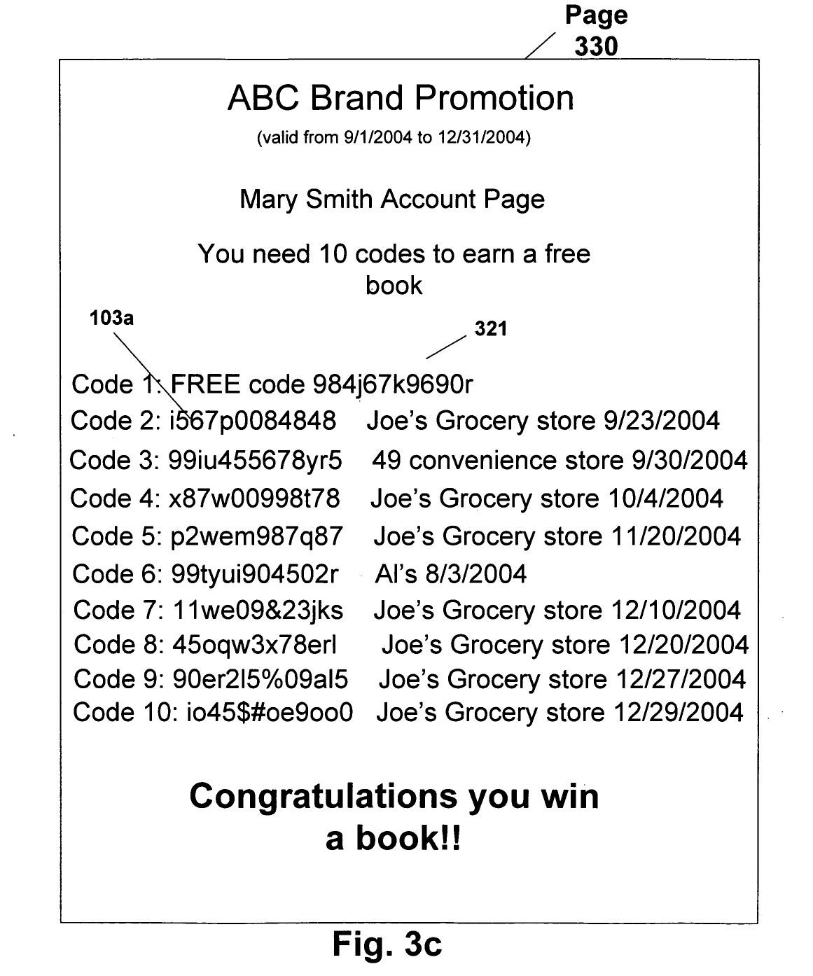

An individual selects the electronic media as shown by logic block 202. In an embodiment, an individual selects the electronic media by clicking on a Web advertisement or clicking on a link in e-mail. An individual completes a registration form in a Web page as seen in logic block 203. A Web page 300, as shown in FIG. 3a, is provided by processing device 102 to processing device 101 in an “ABC Brand Promotion” in an embodiment. Individual 104 inputs a name 301, e-mail address 302 and selected password 303 in Web page 300 which is then transferred back to processing device 102, and in particular promotional Web site 110, in an embodiment. Other individual information may also be input to Web page 300 in alternate embodiments.

A cookie, such as cookie 101c shown in FIG. 1, is then downloaded to processing device 101 from processing device 102 as illustrated by logic block 204. A cookie, in an embodiment, is executable machine-readable instructions or software component that identifies an individual 104, in particular an individual processing device used by individual 104. In an alternate embodiment, a cookie is a general mechanism which a server, such as token enhanced processing device 102, can use to store and retrieve information from a client, such as individual processing device 101, in a client-server network. A cookie is a small piece of information sent by a server or a Web site to store on a client, such as processing device 101, so it can later be read back from that client. This is useful for having the client remember some specific information. In an embodiment, cookie 101c is written to individual processing device 101 by processing device 102. Cookie 101c provides individual information of individual 104 whenever processing device 102 requests the information in an embodiment.

In an alternate embodiment, a cookie is not used and a unique session identification (or sessionid) is generated when individual 104 visits a promotional Web site during a user session. The sessionid or user identification number is used to uniquely identify an individual. The sessionid is then stored in a cookie on the individual's processing device or embedded in any link an individual may click on. A sessionid request is defined as a request that has sessionid information in addition to the request itself. The session continues as long as the individual stays in the links of the first Web page or pages generated from links in the first Web page. A session expires when its age reaches the lifetime set by the server. Information can then be stored on the server and associated with the individual's sessionid. This allows the server to maintain information about a specific individual without relying on a cookie for each piece of information.

A first token is then provided to an account of individual 104 in processing device 102 as illustrated by logic block 205. An individual's (“Mary Smith”) account Web page is provided to processing device 101 as shown by logic block 206. In an embodiment, an individual's account Web page 320 indicates an awarded free token 321 in ABC Brand Promotion. Further, Web page 320 indicates the number of tokens that must be obtained (ten including the free token) during a selected period of time (from Sep. 1, 2004 to Dec. 31, 2004) by buying ABC Brand product from offline retailers and inputting the tokens associated with or included with the purchased ABC Brand products in an individual's account. Also, in an embodiment, Web page 320 indicates the object, such as an incentive or gift (for example a book), awarded to individual 104. In an embodiment, an object such as an incentive or gift, as well as the necessary number of tokens needed, is shown in electronic media 101b.

An individual then obtains one or more additional tokens by purchasing more products or services associated with the promotion as seen by logic block 207. In an embodiment of the invention, an individual goes to an offline retail store to purchase a product having one or more tokens. The individual then enters the token into processing device 101 after accessing the individual's account at promotional web site 110 as represented by logic block 208. In an embodiment, the individual also enters the location of the purchase (for example “Joe's Grocery store,” “49 convenient store”, “Al's” as seen in FIG. 3c) and the purchase date that is recorded and stored by promotional web site 110.

In an alternate embodiment, tokens are not obtained but points or point values are obtained when making a purchase of a product or service and an individual is awarded an object if a predetermined number of points are accumulated during a period of time.

Marketers are then able to analyze individual or group purchasing habits and the effectiveness of an electronic media or Web advertisement. For example, Web page 330 indicates an individual Mary Smith who made a significant number of purchases toward the end of the promotion. If other individuals have similar buying habits, a marketer may be able to estimate or predict purchases toward the end of a promotion based on purchases toward the beginning of the promotion. Further, a marketer is able to quantify how many products were purchased during a period of time in response to a particular electronic media. If a significant number of products were purchased and recorded at promotional site 110 in response to a particular electronic media, a marketer will be more likely to purchase that electronic media.

A determination is then made whether the individual has obtained the necessary number of tokens for an incentive or gift as seen in logic block 208. If the individual has not obtained enough unique codes, the individual repeats logic steps 207 and 208 until the necessary number of tokens is obtained. Otherwise, an individual is notified of the awarded object, such as an incentive, as shown by logic block 210. In an embodiment, individual 104 receives a book as indicted by Web page 330 shown in FIG. 3c.

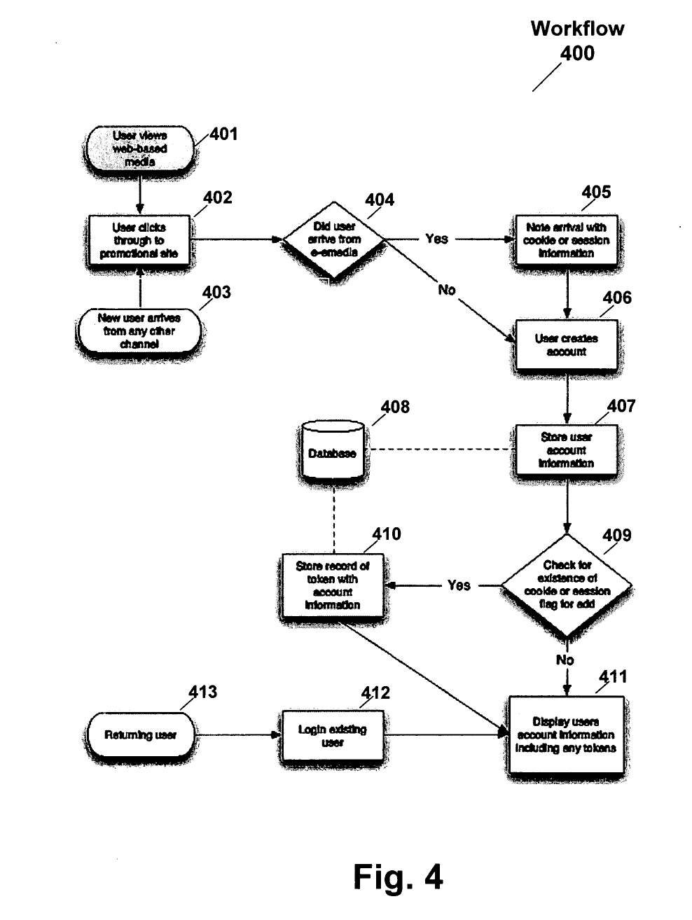

FIG. 4 illustrates a workflow 400 according to an embodiment of the invention. An individual/user views Web-based media or electronic media as illustrated by block 401. An individual/user then selects or clicks on the Web-based media as represented by logic block 402. In an alternate embodiment, an individual/user enters a promotional site through a different channel. For example, a friend tells the individual of the promotional Web site or the individual finds the promotional Web site in response to a query at a search engine. A determination is then made whether the individual arrived to the promotional Web site by way of the electronic media as indicated by logic block 404. If the individual did enter by way of electronic media, a cookie is downloaded to the individual's processing device as illustrated by logic block 405 and control transfers to logic block 406. In an alternate embodiment, user identification number, as described above, is generated when an individual first visits the promotional Web site and used to uniquely identify an individual rather than a cookie. If the individual did not enter by way of electronic media, the individual then creates an individual account. Individual account information is stored in a database 408 illustrated by logic block 407. A determination is made whether an individual processing device has stored a cookie in logic block 409. If the individual processing device has a stored cookie indicating a free token, the information is stored in database 408 as illustrated by logic block 410. Otherwise, individual account information indicating the number of recorded tokens, where purchased and purchase date is provided or displayed to an individual/user as shown by logic block 411.

FIG. 5 illustrates a software architecture 500 stored and executed, at least partially, by token enhanced processing device 102. In an embodiment of the present invention, software 500, or software components of software 500, illustrated by FIG. 5 is stored in an article of manufacture, such as a computer readable medium. For example, software 500 may be stored in a magnetic hard disk, an optical disk, a floppy disk, Compact Disk Read-Only Memory (CD-ROM), Random Access Memory (RAM), Read-Only Memory (ROM), Electrically Erasable Programmable Read-Only Memory (EEPROM) or other readable or writeable data storage technologies, singly or in combination. In an embodiment, software 500 is stored on a computer readable medium associated or included with token enhanced processing device 102.

Software 500 includes multiple software components. For example, software 500 includes individual database 501, account management 503 including award determination 503a having threshold value of tokens for prize value 503b, cookie processing 502 and individual interface 504.

Individual database 501 stores individual information including individual names, e-mail addresses, passwords, number of tokens, when and where the tokens were obtained. In alternate embodiments, other individual information is stored and retrieved from individual database 501. In an embodiment, each individual stored in individual database 501 has an associated unique user identification number.

Account management software 503 is responsible for storing and retrieving information from an individual account in individual database 501, including the recorded number of tokens an individual has input and has been awarded. Account management software 503 also includes award determination 503a for determining whether an individual has won or may be awarded a prize or gift in response to a comparison of the number of tokens recorded in an individual's account stored in database 501 and threshold value 503b.

Cookie processing software 502 is responsible for downloading a cookie, such as cookie 101b, to an individual processing device as well as writing to and reading from the downloaded cookie. In an alternate embodiment, cookie processing software 502 is replaced with user identification software that generates user identification numbers for uniquely identifying individuals as described above.

Individual interface software 504 is responsible for providing a promotional Web site and in particular information, such as Web pages 300, 320 and 330, to an individual as well as retrieving information, such as tokens and individual information from individuals that have been provided by way of an individual processing device and the Internet. Individual interface 504 is also responsible for transferring information between individual processing device 101 and token enhanced processing device 102.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A method comprising:
providing an electronic media;
selecting the electronic media;
inputting individual information;
identifying electronically the individual;
providing a first token associated with the individual information;
obtaining at least a second token by the individual;
inputting the second token at a Web site; and
providing an object in response to a comparison of a threshold value and a number of recorded tokens.

2. The method of claim 1, wherein the electronic media is selected from the group consisting of a web banner, a search result, and an e-mail.

3. The method of claim 1, wherein the token is an alphanumeric code.

4. The method of claim 1, wherein the selecting includes the individual clicking on the electronic media.

5. The method of claim 1, wherein the individual information includes an individual name, password and an individual e-mail address.

6. The method of claim 1, wherein the identifying includes downloading a cookie to an individual processing device or generating a user identification number during a user session.

7. The method of claim 1, wherein the obtaining includes purchasing a product having the second token.

8. The method of claim 1, wherein the obtaining includes purchasing a service associated with the second token.

9. The method of claim 1, wherein the providing the object is selected from the group consisting of downloadable music, a gift certificate, incentive, digitally downloadable asset or book.

10. The method of claim 1, further comprising:
inputting a third or more tokens at the Web site after a purchase of a product including the third or more token.

11. A method for identifying measurable loyalty of an individual to a product, comprising:
providing an electronic media;
selecting the electronic media by the individual;
inputting individual information by the individual;
identifying electronically the individual;
displaying a first token associated with the individual information to the individual processing device;
purchasing the product, by the individual, having at least a second token;
inputting the second token, by the individual, at the individual processing device; and
providing an object in response to a comparison of a threshold value and a number of recorded tokens

12. The method of claim 11, wherein the individual information includes an individual name, password and an individual e-mail address.

13. A processing device, comprising:
a storage device;
a processor, coupled to the storage device,
the storage device storing a software program for controlling the processor; and
the processor operative with the software program to:
obtain individual information in response to an individual selection of an electronic media;
identify electronically the individual;
display a first token associated with the individual information;
obtain at least a second token obtained from a product purchased by the individual; and
determine whether to provide an object to the individual in response to a comparison of a threshold value and a number of recorded tokens.

14. The processing device of claim 13, wherein the individual information includes an individual name, password and an individual e-mail address.

15. The processing device of claim 13, wherein identify electronically the individual includes downloading a cookie to an individual processing device or generating a user identification number during a user session.

16. The processing device of claim 13, wherein the electronic media is selected from a group consisting of a Web banner, a search result on a Web page, and an e-mail.

17. The processing device of claim 13, wherein an individual processing device provides the individual information to the processing device by way of the Internet.

18. The processing device of claim 13, wherein the individual processing device is a mobile device.

19. The processing device of claim 18, wherein the processing device provides the first and second tokens to the individual processing device for display and the processing device provides an indication of how many tokens are required to obtain an object.

20. An article of manufacture, including a computer readable medium, comprising:
a software component to obtain individual information in response to an individual selection of an electronic media;
a software component to uniquely identify the individual;
a software component to display a first token associated with the individual information;
a software component to obtain at least a second token obtained from a product purchased by the individual; and
a software component to determine whether to provide an object to the individual in response to a comparison of a threshold value and a number of recorded tokens.

21. The article of manufacture of claim 20, wherein the individual information includes an individual name, password and an individual e-mail address.

22. The article of manufacture computer of claim 20, wherein the software component to uniquely identify the individual includes downloading a cookie to an individual processing device or generating a user identification number during a user session.

23. The article of manufacture of claim 20, wherein the electronic media is selected from a group consisting of a Web banner, a search result on a Web page, and an e-mail.
